(19) United States
(12) Patent Application Publication
(10) Pub. No.: US 2011/0188671 A1
(43) Pub. Date: Aug. 4, 2011

(54) ADAPTIVE GAIN CONTROL BASED ON SIGNAL-TO-NOISE RATIO FOR NOISE SUPPRESSION

(75) Inventors: David V. Anderson, Alpharetta, GA (US); Devangi N. Parikh, Atlanta, GA (US); Sourabh Ravindran, Dallas, TX (US)

(73) Assignee: Georgia Tech Research Corporation, Atlanta, GA (US)

(21) Appl. No.: 12/905,794

(22) Filed: Oct. 15, 2010

Related U.S. Application Data
(60) Provisional application No. 61/251,990, filed on Oct. 15, 2009.

(51) Int. Cl. H04B 15/00

(52) U.S. Cl. 381/94.3

(57) ABSTRACT

Systems and methods for suppressing noise in a signal are disclosed herein. In exemplary embodiments of the present invention, noise is suppressed using perceptual adaptive gain control based on signal-to-noise ratios. In other embodiment of the present invention, the gain of a signal is mapped as a function of an active estimate of the envelope of the signal.

### CROSS-REFERENCE TO RELATED APPLICATIONS

This application claims the benefit of U.S. Provisional Patent Application No. 61/251,990, filed on 15 Oct. 2009, entitled “Adaptive Gain Control based on Signal-to-Noise Ratio for Noise Suppression”, which is hereby incorporated by reference as if fully set forth below.

### TECHNICAL FIELD

Embodiments of the present invention relate generally to signal processing devices and systems and, more particularly, to systems, devices, and methods for removing background noise from audio signals.

### BACKGROUND

Speech enhancement and noise suppression algorithms are widely used in communication devices such as Bluetooth devices, public address systems, cellular phones, hearing aids, teleconferencing equipments, and the like. Conventional systems attempt to reduce, if not eliminate, background noise in a signal without altering the quality of the intended signal, such as speech. These conventional systems also attempt to perform noise suppression algorithms with very little computational delay. Low delay can be of the utmost importance in applications such as hearing aids where a delay can lead to a discrepancy in audio and visual perception or increased acoustic feedback.

Early technology sought to accomplish the elimination of noise through the use of adaptive Wiener filters and other computational intense circuits. A problem with these systems is that in eliminating the noise from a signal, the systems fail to preserve the quality of the speech present in the signal. This problem arises because these systems can be mathematically optimized to reduce the total error in a signal. Conventional systems reduce human perception of the quality of speech within the processed signal because humans do not hear total error. Humans are very sensitive to particular sounds and artifacts but not to others. Later systems sought to solve this problem with systems that attempted to estimate the spectrum of a signal.

The single microphone noise suppression techniques described thus far require a method to estimate the noise spectrum in the corrupted speech. Usually, a voice activity detector (VAD) is used to detect the speech pauses in noisy speech and estimate the noise spectrum made during those pauses. Methods like spectral subtraction assume that the noise affects the speech spectrum uniformly over the entire spectrum. Multi-band spectral subtraction takes into consideration this assumption by segmenting the signal into different frequency bands and then performing spectral subtraction. Both of these methods use non-linear processing that can add musical noise to the signal, and can further distort the speech signal resulting in unnatural perceived speech.

Conventional noise estimating systems present several problems. First, if the system estimates the signal incorrectly and mistakenly categorizes speech as noise, then parts of speech are eliminated. Second, these systems fail to consider the parts of speech to which humans are especially sensitive. Specifically, these systems fail to place emphasis on the particular sounds that humans believe enhance the quality of speech. Therefore, these systems seek only to minimize the noise present in a signal without careful consideration paid to the amount of the speech signal sacrificed by the process. Third, these systems create high amounts of distortion in the processed signal through the use of Fast Fourier Transforms (FFT). FFTs are the computational tools used by these systems to rapidly change the gains applied to the input signal. In these systems, it is necessary to rapidly change the gains applied to the signal in order to protect the speech signal when attempting to eliminate noise. Thus, these systems face either rapidly changing the gain, which creates distortion in the signal, or keeping the gain more constant, which eliminates parts of the speech signal. Finally, the complex mathematical calculations required by these systems results in delays exceeding 20 milliseconds. Such long delays are undesirable in many applications.

Current speech enhancement systems that utilize only one microphone are unable to sufficiently restore speech signals in many noisy environments. Classical techniques of speech enhancement and noise suppression using a single microphone are reaching a saturation point in terms of performance. The bottleneck in most of these techniques, as discussed above, arises in estimating the noise spectrum correctly, especially in non-stationary noise cases. But, multiple-microphone noise suppression techniques can partially solve this problem because they are able to make use of the additional information to separate signals coming from spatially disparate sources. Blind source separation (BSS) is a technique that can separate sources that have been mixed in an unknown mixing environment. Current BSS systems exhibit limited performance in real convolutive mixing environments and, in general, 100% separation is not practical and is believed impossible.

A common approach to BSS for audio signals is the application of adaptive filters to estimate the unmixing matrix by minimizing the mutual information in the system outputs. If a sufficient amount of separation is assumed, it is possible to use statistical enhancement techniques to further enhance the BSS outputs. For example, several researchers have demonstrated that it is possible to use the spectral estimates of two BSS-output signals to generate a Wiener filter to remove residual cross-talk and noise and thereby improve the signal-to-interference ratio (SIR). But, these post-processing systems do not necessarily improve the perceptual quality of speech within a signal. Instead, by blindly reducing the amount of noise in a speech signal, these systems introduce artifacts and musical noise into the speech. Further, these systems suffer from the same problems with delay as the single microphone systems mentioned above. Specifically, the delay present in post-processed BSS outputs using Wiener filters may exceed 20 milliseconds.

### SUMMARY

Briefly described, embodiments of the present invention relate to systems and methods for suppressing noise in a signal. Embodiments of the present invention comprise noise suppression systems and methods that are adapted to address problems in the prior art. Embodiments of the present invention start minor human perception and how the brain works to receive sound. Embodiments of the present invention significantly enhance the quality of speech in a signal through use of perception-based processing. Additionally, some embodiments of the invention are adapted to reduce, if not eliminate, distortion in signals by mimicking the processes of a human ear. Although some distortion may still be present in the processed signal, the distortion sounds natural to a human. Further, some embodiments of the present invention are adapted to reduce the perceptual effect of noise to a human.

Embodiments of the current invention provide techniques of noise suppression using perceptual automatic gain control (AGC) systems that expand a signal so that the noise floor of the signal is pushed down in regions with a low Signal-to-Noise Ratio (SNR) and hence the effect of noise is reduced. This method does not require a VAD system and is of low computational complexity. Some embodiments of the present invention use a model based on the human auditory system and, thus, produce enhanced speech that is natural sounding. But, instead of lowering the noise floor when the SNR in the sub-band is low, these conventional systems amplify the speech when the SNR in the sub-band increases. Therefore, even if the gain is limited, this boosting of the speech signal may cause the speakers to saturate and lead to distortions in the speech. Further, the gain parameters used in these systems are not dynamically determined based on the quality of the signal.

Some embodiments of the present invention relate to a noise suppression system comprising a filter bank, a plurality of channels, and a signal summation device. The filter bank can contain a plurality of filters and can be configured to receive an input, which may contain noise. The filter bank can also be in communication with the plurality of channels. Each channel in the plurality of channels can be configured to receive a sub-band signal corresponding to a predetermined frequency range. Each channel can also comprise a gain calculation subsystem and a gain multiplier device. The gain calculation subsystem can be configured to map a gain to be applied to a sub-band signal by the gain multiplier device. The gain can be a function of an active estimate of the envelope of a sub-band signal. In some embodiments of the present invention, a BSS system is in communication with the filter bank. The BSS system can output signals that are filtered in the filter bank.

Other embodiments of the present invention relate to a method of suppressing noise in a signal. The method can comprise providing an input signal, filtering the input signal to a plurality of sub-band signals, calculating a separate gain for each sub-band signal, applying the calculated gains to each sub-band signal, and combining the plurality of sub-band signals to form a processed output signal. The sub-band signals can have predetermined frequency ranges corresponding to the passbands of filters in the filter bank. The gain can be a function of an active estimate of envelopes of each of the plurality of sub-band signals. In some embodiments of the present invention, the input signal is the output signal of a BSS system.

These and other aspects of the present subject matter are described in the Detailed Description below and the accompanying figures. Other aspects and features of embodiments of the present invention will become apparent to those of ordinary skill in the art, upon reviewing the following description of specific, exemplary embodiments of the present invention in concert with the figures. While features of the present invention may be discussed relative to certain embodiments and figures, all embodiments of the present invention can include one or more of the features discussed herein. While one or more embodiments may be discussed as having certain advantageous features, one or more of such features may also be used with the various embodiments of the invention discussed herein. In similar fashion, while exemplary embodiments may be discussed below as system or method embodiments it is to be understood that such exemplary embodiments can be implemented in various devices, systems, and methods.

### BRIEF DESCRIPTION OF THE DRAWINGS

The following Detailed Description of preferred embodiments is better understood when read in conjunction with the appended drawings. For the purposes of illustration, there is shown in the drawings exemplary embodiments. But, the subject matter is not limited to the specific elements and instrumentalities disclosed. In the drawings:

FIG. 1 is a diagram of dynamic mapping of an envelope of a signal in accordance with an exemplary embodiment of the present invention.

FIG. 2 is a block diagram of a noise suppression system in accordance with an exemplary embodiment of the present invention.

FIG. 3A is graphical representation of a noisy speech signal at 12 dB SNR in accordance with an exemplary embodiment of the present invention.

FIG. 3B is a graphical representation of a noise suppressed speech signal in the time domain in accordance with an exemplary embodiment of the present invention.

FIG. 4A is a graphical representation of a noisy speech signal corrupted with white noise at 12 dB SNR in accordance with an exemplary embodiment of the present invention.

FIG. 4B is a graphical representation of a noise suppressed speech signal in the frequency domain in accordance with an exemplary embodiment of the present invention.

FIG. 5 is a graphical representation of gain G vs. eᵢ/eᵢₘₐₓ for different values of an effective dynamic range in accordance with an exemplary embodiment of the present invention.

FIG. 6 is a graphical representation of a noisy speech signal corrupted with white noise at 5 dB SNR and of a noise suppressed speech signal in accordance with an exemplary embodiment of the present invention.

FIG. 7 is a constrained blind source separation configuration in accordance with an exemplary embodiment of the present invention.

FIG. 8 is a diagram of post-processing performed using an FFT filter bank for an adaptive Wiener filtering in accordance with an exemplary embodiment of the present invention.

FIG. 9 is a system of post processing performed using an FFT filter bank for an adaptive Wiener filtering and using a constant-Q filter bank for the perceptual enhancement system in accordance with an exemplary embodiment of the present invention.

FIG. 10 is a graphical representation of a mixture output of BSS and output of perceptual post-processing with a SNR of about −2 dB in accordance with an exemplary embodiment of the present invention.

FIG. 11 is a graphical representation of a mixture output of BSS and output of perceptual post-processing with an SNR of about 0 dB in accordance with an exemplary embodiment of the present invention.

FIG. 12 is a graphical representation of gain G vs. eᵢ/eᵢₘₐₓ for different values of an effective dynamic range in accordance with an exemplary embodiment of the present invention.

FIG. 13 is a block diagram of an exemplary perceptual AGC based noise suppression system in accordance with an exemplary embodiment of the present invention.

### DETAILED DESCRIPTION

To facilitate an understanding of the principles and features of the invention, various illustrative embodiments are explained below. In particular, the invention is described in the context of being systems and methods for suppressing noise in a signal. Embodiments of the invention, however, are not limited to use in processing auditory speech signals. Rather, embodiments of the invention can be used for processing other signals.

The components described hereinafter as making up various elements of the invention are intended to be illustrative and not restrictive. Many suitable components that would perform the same or similar functions as the components described herein are intended to be embraced within the scope of the invention. Such other components not described herein can include, but are not limited to, for example, similar components that are developed after development of the invention.

Various embodiments of the present invention comprise a noise suppression system. Exemplary embodiments of noise suppression systems can comprise a filter bank, plurality of channels, and a signal summation device.

The filter bank can comprise a plurality of filters. The filters can each have a bandwidth. The filters can separate an input signal into a plurality of sub-band signals corresponding to the bandwidth of the filters. The sub-band signals can then traverse through a respective channel based on the frequency range of each sub-band signal.

The each channel in the plurality of channels can comprise a gain calculation subsystem and a multiplier unit. The gain calculation subsystem can calculate a gain to be applied to each sub-band signal by the multiplier device.

The signal summation device can combine each of the sub-band signals from the plurality of channels to provide an output of the noise suppression system.

Some embodiments of the present invention use a multiplicative perceptual AGC system to linearly expand the envelope of a signal, which results in noise suppression. An acoustic signal can be expressed as,

$$s ( t ) = {\sum }_{i} {e}_{i} ( t ) {v}_{i} ( t ) \qquad Equation 1$$

where vᵢ(t) is a rapidly varying speech excitation and eᵢ(t) is the slowly varying speech envelope in the i^{th} channel or sub-band. The human ear responds to the intensity of the envelope eᵢ(t) in each sub-band. It can be assumed that the noise floor in each channel corresponds to the minimum of the envelope eᵢₘᵢₙ in that channel. If the envelope eᵢ(t) is mapped such that the noise floor is mapped to a fraction of its original value, then the noise can be suppressed in the resulting signal. In some embodiments of the present invention, a multiplicative perceptual AGC model can be followed to non-linearly expand the envelope in each channel. The relationship between the non-linearly compressed envelope and the original envelope can be expressed as,

\hat{e}ᵢ(t)=βeᵢ^{α}(t) Equation 2

Equation 2 is expressed as it is herein for convenience; but, in practice it can be helpful to normalize prior to the exponent for numerical reasons.

The power law compression can be rewritten as the multiplicative gain,

\hat{e}ᵢ(t)=G(t)eᵢ(t) Equation 3

where G(t)=βeᵢ^{α-1}(t). Taking the logarithm of Equation 2,

log \hat{e}ᵢ(t)=α log eᵢ(t)+log β Equation 4

The parameters α and β can be computed based on the amount that the envelope will be compressed or expanded. In some embodiments, a gain function is desired such that the maximum level of the input envelope remains the same, while the minimum of the processed envelope is a linearly scaled version of the minimum of the input envelope. This can be represented by,

êᵢₘₐₓ=eᵢₘₐₓ Equation 5

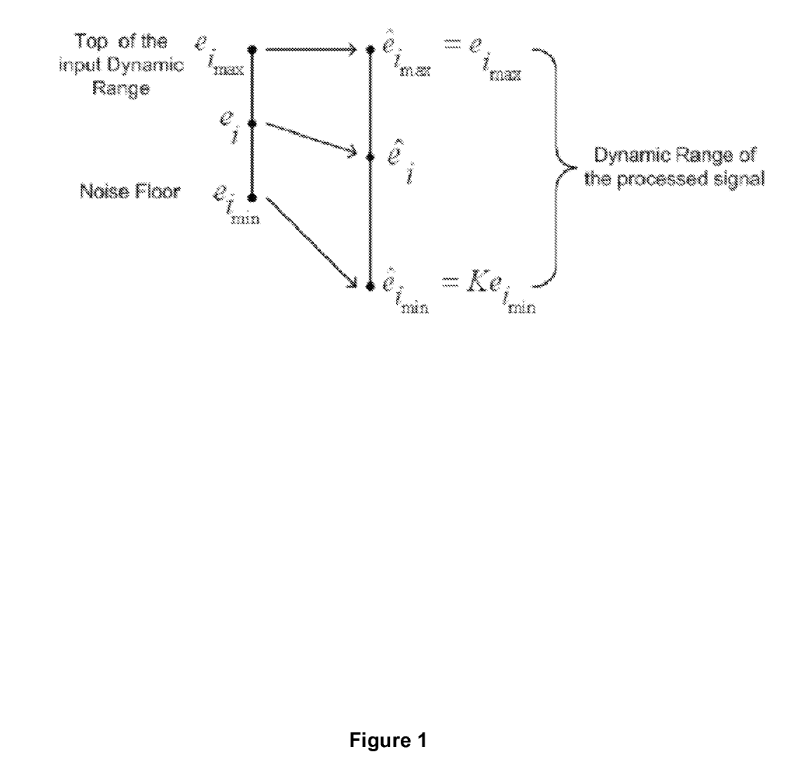

êᵢₘᵢₙ=Keᵢₘᵢₙ Equation 6

where eᵢₘₐₓ and êᵢₘₐₓ are the maximum of the original and the gain-modified envelopes respectively and eᵢₘᵢₙ and êᵢₘᵢₙ are the minimum of the original and the gain modified envelopes respectfully. As used herein, K is the expansion constant. If the value of K is set at a value greater than one, the signal is compressed, while if the value of K is set at a value less than one, the signal is expanded. The signal remains unaltered for a value of K equal to one. For low SNR signals, if the value of K is less than one, then the signal is expanded which lowers the noise floor of the signal. This can be visualized by a line diagram shown in FIG. 1.

Using Equation 5 and Equation 6 in Equation 4 and solving for α and β, it can be found that

$$\begin{matrix}β = {e}_{i max}^{( 1 - α )} & Equation 7 \\ α = 1 - \frac{log K}{log M} & Equation 8\end{matrix}$$

where K is given by Equation 6 and

$$M = \frac{{e}_{i max}}{{e}_{i min}} \qquad Equation 9$$

The minimum of the envelope can be used as an approximation of the noise level in the noisy signal. The ratio in Equation 9 is proportional to the peak SNR of the signal. Equation 9 can yield an idea of the effective dynamic range of the input signal. The gain function to be applied to the sub-band signal is then given by,

$$G = β {e}_{i}^{( α - 1 )} = {( \frac{{e}_{i max}}{{e}_{i}} )}^{P} \qquad Equation 10$$

where P is equal to log(K)/log(M). Because M is greater than or equal to one, the gain can be found as,

$$G \{ \begin{matrix}\geq 1 when K \geq 1 \\ < 1 when K < 1\end{matrix} \qquad Equation 11$$

As explained above, in some embodiments of the present invention, if the value of K is between zero and one, then the envelope of the signal can undergo expansion. Equation 10 can be rewritten as,

$$G = {( \frac{{e}_{i}}{{e}_{i max}} )}^{- \frac{log K}{log M}} \qquad Equation 12$$

Because the value of K is between zero and one, log(K) is less than zero, therefore Equation 12 can be rewritten as,

$$G = {( \frac{{e}_{i}}{{e}_{i max}} )}^{\frac{\vert log K \vert}{log M}} \qquad Equation 13$$

If the value of eᵢ is close to eᵢₘₐₓ, then the instantaneous SNR is high. For this case, the value of K should be closer to one so that the gain is close to unity. On the other hand, if eᵢ is much less than eᵢₘₐₓ, the instantaneous SNR is low and hence the value of K should be closer to zero so that the gain, G, is small. Some embodiments of the present invention approach this by setting,

$$K = \frac{{e}_{i}}{{e}_{i max}} \qquad Equation 14$$

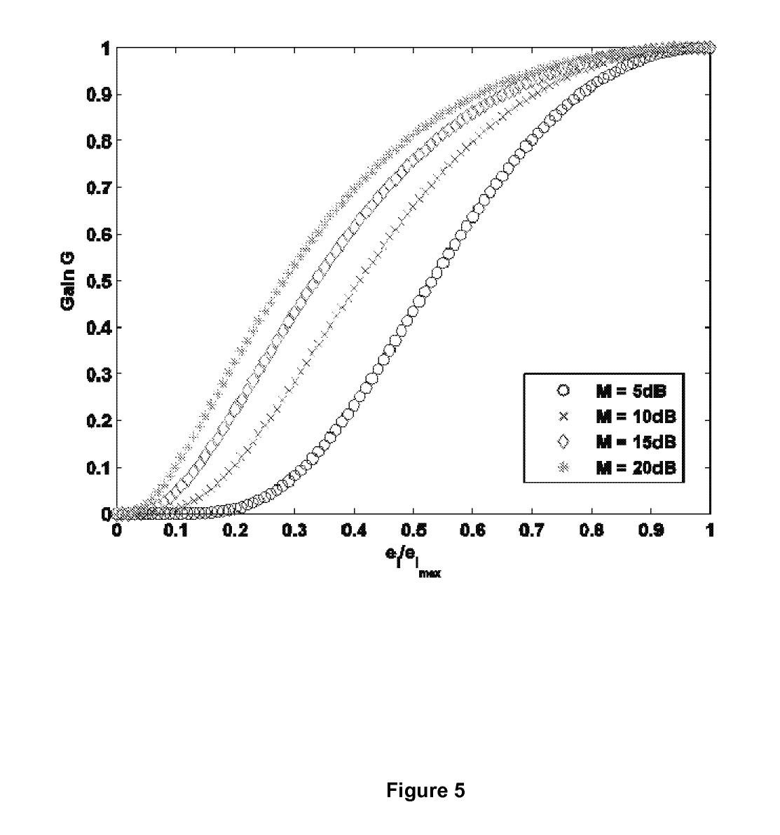

The gain G is obtained by using this form of K is shown in FIG. 5 for different values of the effective dynamic range.

The expression for K can be rewritten to,

$$K = \frac{{e}_{i}}{{e}_{i max}} = \frac{{e}_{i}}{{e}_{i min}} \cdot \frac{{e}_{i min}}{{e}_{i max}} = \frac{{SNR}_{i}}{M} \qquad Equation 15$$

K set in this form is proportional to the instantaneous normalized SNR. An exemplary embodiment of a mapping of the envelope of the signal is illustrated in FIG. 1.

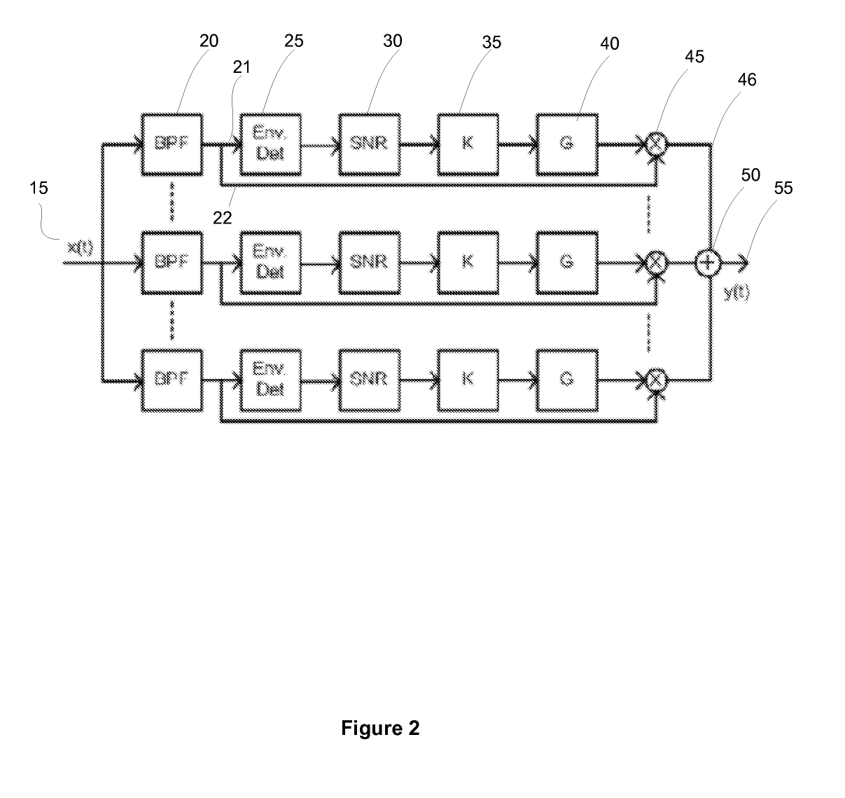

FIG. 2 illustrates a block diagram of an exemplary perceptual noise suppression system. An input signal 15 containing both speech and noise is transmitted into the system 10. The system 10 can have a plurality of channels or sub-bands. Each channel or sub-band allows a particular band of frequencies to pass through the channel or sub-band. The particular band of frequencies can be determined by the passbands of the filters 20 in the filter bank. The channels or sub-bands are formed by a filter bank comprising a plurality of filters 20. The input signal 15 enters the filter bank where it can be split into different channels or sub-band signals by each filter 20. Each system can have any number of channels or sub-bands. In exemplary embodiments of the present invention, the system has between 20 and 30 channels necessary to closely resemble the functionality of the human ear. The filters 20 can be any type of filter, including but not limited to infinite impulse response (IIR) filters, finite impulse response (FIR) filters, Chebyshev filters, Butterworth filters, Elliptic filters, and the like. In an exemplary embodiment, the filters 20 are bandpass filters. The filters 20 can be any bandpass filters, which are known in the art or later developed, including but not limited to second order Butterworth filters, fourth order Butterworth filters, and the like. In some embodiments, the bandwidth filters in the filter bank are spaced such that low frequencies have low bandwidth and high frequencies have high bandwidth, which is similar to the function of the human ear. In each channel, after the signal 15 passes through a filter 20, the signal is split into a first output 21 and second output 22. The second output 22 is transmitted to a gain multiplier device 45 while a first output 21 is transmitted to a series of devices to calculate the gain that will be applied to the second output.

The gain to be applied to each sub-band signal can be calculated by a gain calculation subsystem. The gain calculation subsystem can comprise an envelope detection device 25, a SNR estimation device 30, an expansion constant calculation device 35, and a gain calculation device 40. An envelope detection device 25 can determine the instantaneous or near instantaneous short-term amplitude of the first output 21 sub-band signal. In an exemplary embodiment of the present invention, the envelope detection device comprises a full-wave rectifier followed by a low-pass filter. A SNR estimation device 30 uses data computed by the envelope detection device 25 to estimate the noise floor of the first output 21 sub-band signal and the SNR of the first output. In an exemplary embodiment, the SNR estimation device 30 comprises memory, which can be used to estimate the noise floor of the first output 21 sub-band signal at a particular time based on the noise floor of the first output 21 sub-band signal at prior times. An expansion constant calculation device 35 can use information obtained from the SNR estimation device 30 to determine an expansion constant parameter to be used in calculating gain. In an exemplary embodiment the expansion constant calculation device 35 uses the methods and formulas described herein. A gain calculation device 40 uses information obtained from the expansion constant calculation device 35 to map the signal from its current level to a desired level. In an exemplary embodiment of the present invention, the gain is calculated using the methods and formulas described herein. The gain determined by the gain calculation device 40 is then applied to the second output 22 sub-band signal at a gain multiplier device 45. Finally, the output 46 of each channel is transmitted to a signal summation device 50 that adds the outputs 46 of each channel to form a processed signal 55.

Although not shown in FIG. 2, in some embodiments of the present invention, the outputs 46 of each channel or sub-band may pass through an additional filtering system, which can remove distortion introduced to the output 46 of each channel by the system 10. In other embodiments, the outputs 46 of each channel or sub-band may pass through an additional filtering system and then pass to a signal summation device 50 that forms a processed signal 55.

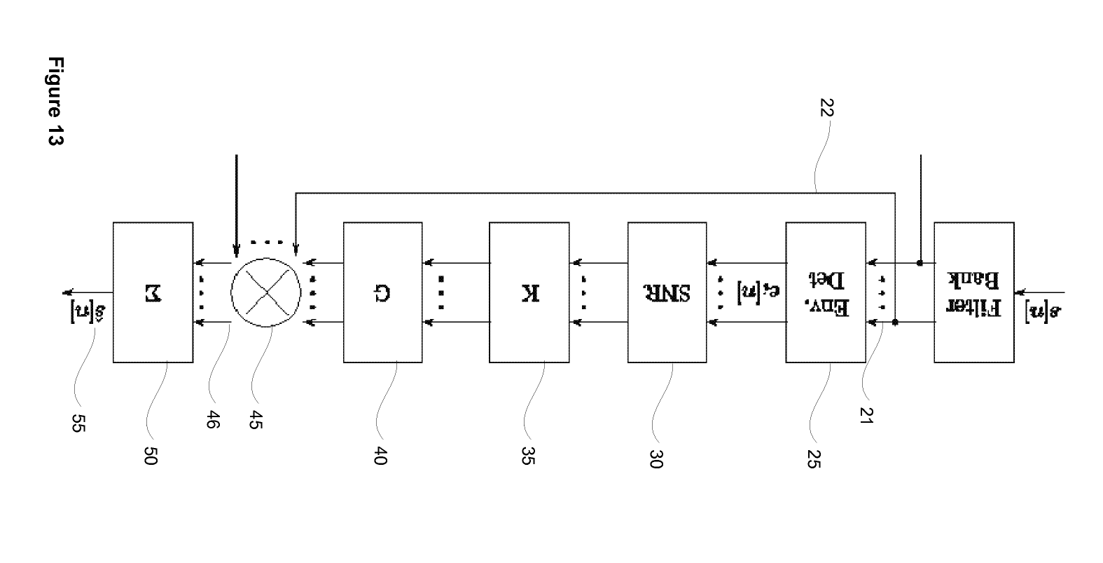

Referring to FIG. 13, a block diagram of an exemplary embodiment of the present invention is shown. To model the critical band of the cochlea, some embodiments of the invention use a constant-Q filter bank. When a signal is sampled at 16 kHz, the sub-bands or channels can be obtained by filtering the signal into twenty-three one-third octave bands using a 2^{nd} order roll-off Butterworth filter. The envelope of each channel can be extracted using a full-wave rectifier followed by a low-pass filter. The value for the cutoff frequency of these low-pass filters can be selected to be a fraction of the corresponding bandwidth of the channel. The cutoff frequencies can then be set as ⅕^{th}, ⅛^{th}, and 1/15^{th} of the bandwidth of low, medium, and high frequency channels respectively. These fractions can be selected to make sure that the envelope tracks the signal closely but at the same time does not change too rapidly, which causes the gain to change rapidly. This is usually undesirable as it may add musical noise to the output. The maximum and the minimum of each envelope can be calculated, which can be the estimates of the signal level and the noise floor respectively. The gain parameters K, β, and α can be calculated from Equation 14, Equation 7, and Equation 8 respectively. These gain parameters can in turn be used to calculate the gain G. This gain can then be multiplied by the sub-band signal. All the sub-band signals can then be added up to obtain the resulting expanded noise suppressed signal. Because the envelope is more slowly varying than the signal, computational requirements may be lessened by calculating the gain at a slower rate commensurate with the envelope bandwidth.

Due to the low complexity of some embodiments of the invention, implementation can occur in real-time with relative ease. In some embodiments, for real-time implementation the signal can be processed in blocks. The block size can be determined based on the memory available. Block processing can ensure that continuity in the processing is maintained between the blocks. The filter states can be preserved from the previous block and used for the processing of the current block. The peak SNR calculated in Equation 9 can be the peak SNR of each channel and not the peak SNR of each block. Therefore, the signal level estimated by eᵢₘₐₓ can be the maximum of the entire channel and not just a single block. This maximum can be calculated as,

(eⱼ)ᵢₘₐₓ=max((eⱼ)ᵢₘₐₓ,γ(eⱼ₋₁)ᵢₘₐₓ) Equation 16

where γ≈1 but γ is less than one, (eᵢ)ᵢₘₐₓ is the maximum of the envelope of the j^{th} block of the i^{th} channel of the signal, and (eⱼ₋₁)ᵢₘₐₓ is the maximum of the previous block of the i^{th} channel.

Discontinuous gain G from one block to another can cause undesirable artifacts in the output. Gain continuity can be obtained by interpolating the gain at the end of the previous block to the gain in the current block.

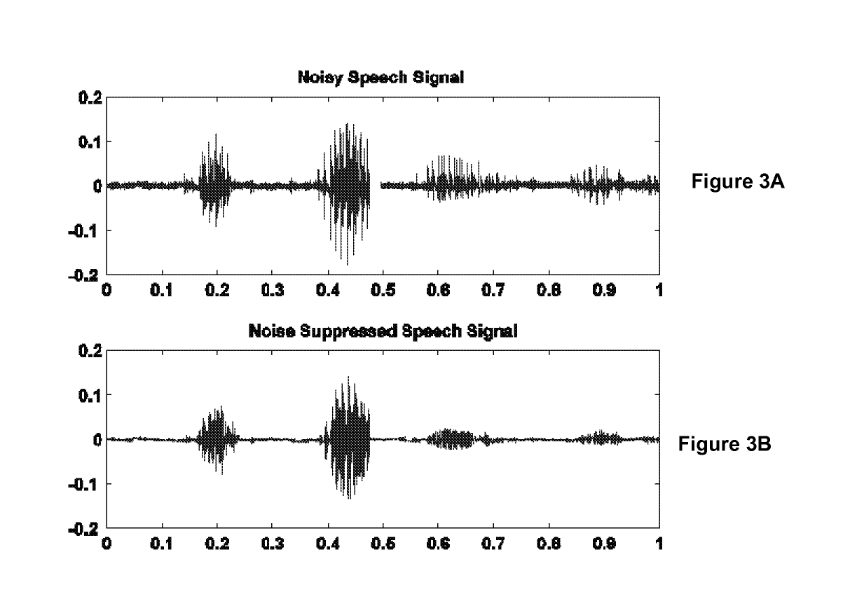

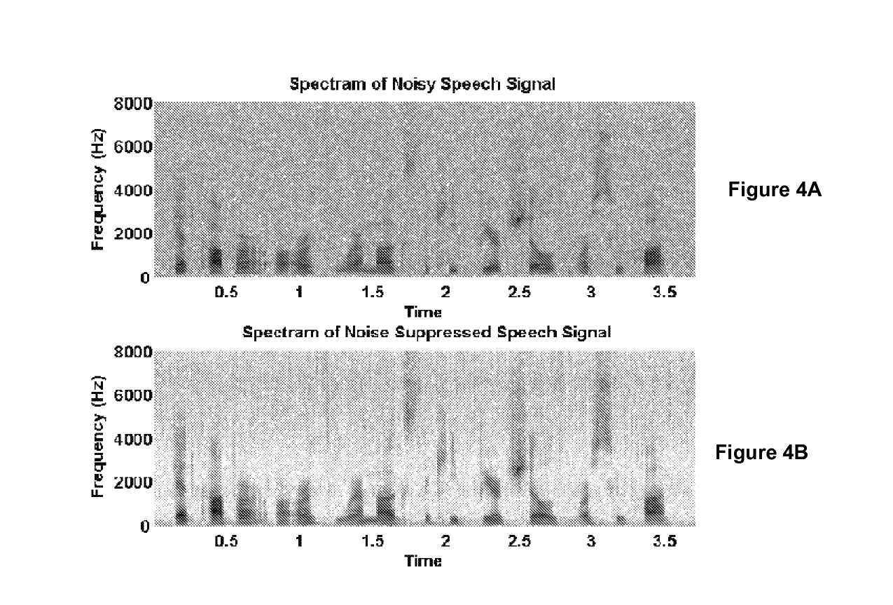

FIGS. 3A and 3B provide a graphical illustration of the present invention that has processed a speech signal corrupted with white noise at 12 dB SNR to considerably lower the noise level in the processed signal. This noise suppression result can also be seen in the spectrogram of FIGS. 4A and 4B. The background noise has been reduced while the speech energy has been maintained with little change.

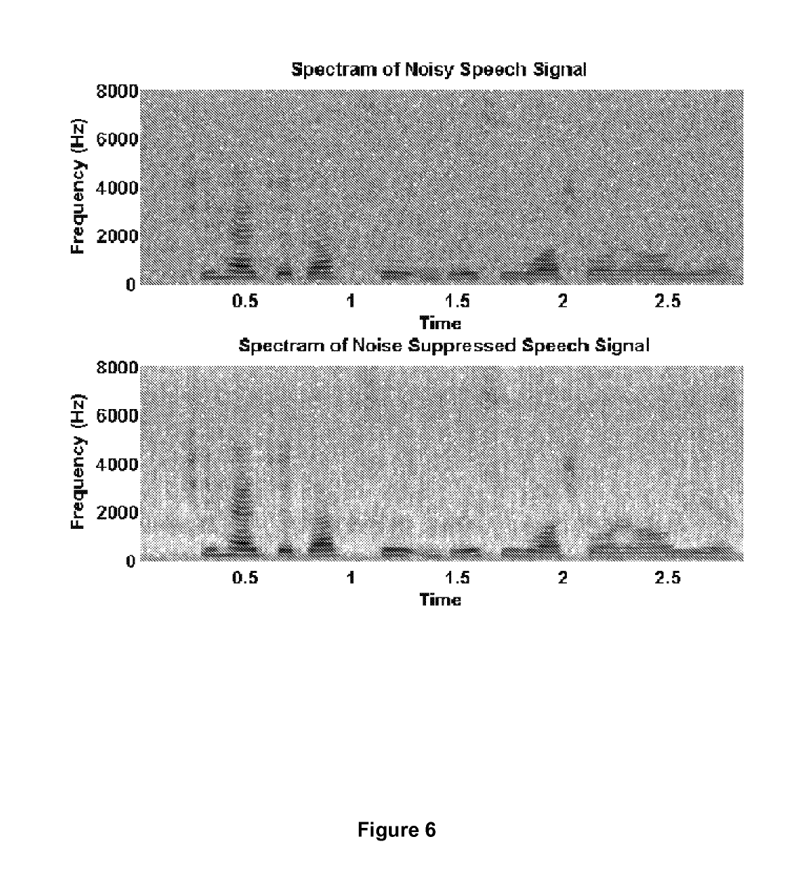

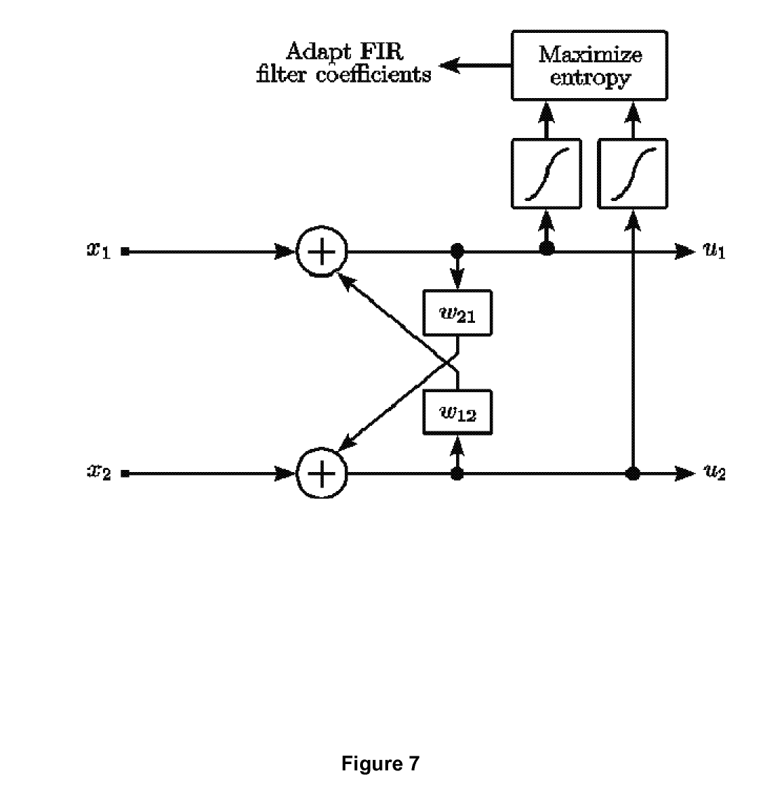

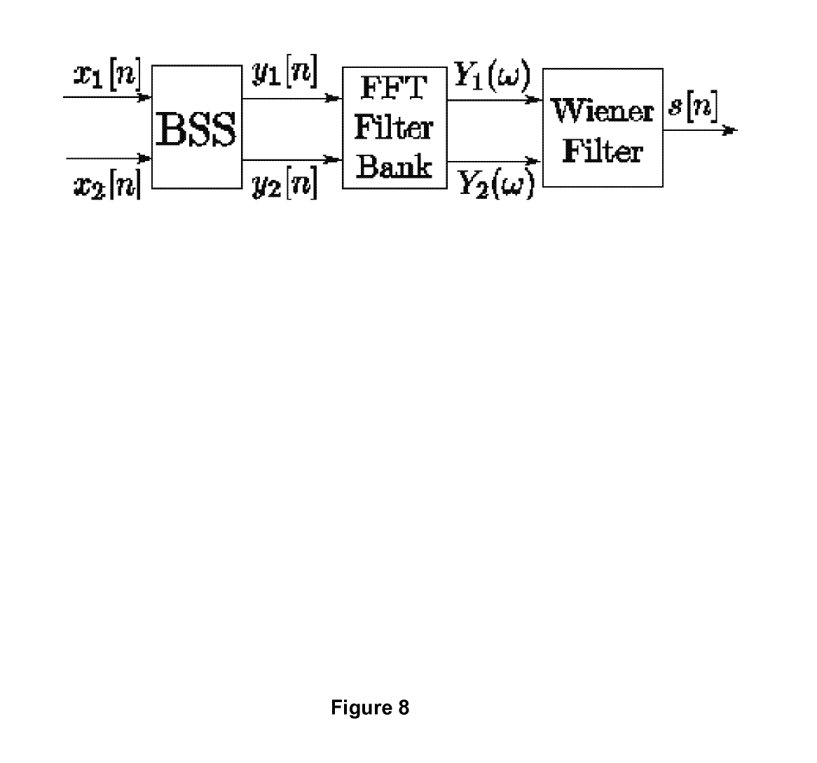

In some embodiments of the present invention where signals have very low SNR, such as SNR approaching 0 dB, the approximation of the SNR that is used is not accurate because the noise floor may be at a much higher level than the minimum of the envelope. This incorrect estimate of the SNR can add noise to the processing. This can be seen in the spectrogram of an exemplary signal in FIG. 6. But, the quality of the speech can be preserved. This is validated through the results of subjective testing.

A subjective test was conducted to evaluate the performance of embodiments of the present invention compared to three other standard noise suppression methods—specifically, spectral subtraction (SpecSub), multi-band spectral subtraction (Mband), and an iterative Wiener algorithm based on an all-pole speech production model. The code for the three models is illustrated in Speech Enhancement: Theory and Practice, P. Loizou, CRC Press, 2007. The models were tested in four different noisy conditions and at three different noise levels. The noise samples were obtained from the NoiseX database. The noisy speech samples were generated by adding white noise, babble noise, F-16 cockpit noise, and the noise inside a military vehicle (Leopard 1) at 5 dB, 12 dB, and 20 dB SNR.

Eleven native English speaking subjects were presented with pairs of speech samples processed with different noise suppression algorithms and were asked to rate the quality of one sample compared to the other. The subjects were asked to rate the quality of the speech “Q” depending on the intelligibility, distortions, and the sample's natural sound. The allowable responses were that the 2^{nd} sample was much better “3,” better “2,” slightly better “1,” about the same “0,” slightly worse “−1,” worse “−2,” and much worse “−3” to choose from. The subjects were also asked to rate the overall noise level “N” of one sample compared to the other. The possible three ratings in this case were: less noisy “1,” about the same “0,” and more noisy “−1”. The subjects were allowed to replay the samples as many times as they liked. 36 pairs of samples were presented to each subject.

The results of the subjective test are summarized in Tables 1-3. The values in the Tables 1-2 indicate on an average how the prior noise suppression systems were rated compared to an embodiment of noise suppression system and method of the current invention. The values in Tables 1-3 correspond to the ratings mentioned in the previous paragraph. Overall, the exemplary noise suppression system of the present invention outperformed prior systems in terms of preserving the quality of speech and rated on par with prior systems in terms of noise level in the processed output.

TABLE 1

| | Q | N |
|---|---|---|
| SpecSub | −1.15 | −0.06 |
| MBand | −0.86 | −0.09 |
| Wiener | −0.56 | 0.43 |

TABLE 2

| | White | | Babble | | F16 | | Leopard | |
|---|---|---|---|---|---|---|---|---|
| | Q | N | Q | N | Q | N | Q | N |
| SpecSub | −1.09 | −0.15 | −1.33 | −0.12 | −0.87 | 0.27 | −1.30 | −0.21 |
| MBand | −0.81 | −0.15 | −1.39 | −0.30 | −0.78 | 0.18 | −0.45 | −0.09 |
| Wiener | −0.27 | 0.54 | −0.87 | 0.18 | −0.87 | 0.45 | −0.24 | 0.57 |

TABLE 3

| | | |
|---|---|---|
| 5 dB SNR | 12 dB SNR | 20 db SNR |

| | Q | N | Q | N | Q | N |
|---|---|---|---|---|---|---|
| SpecSub | −1.45 | 0.30 | −1.57 | −0.03 | −1.57 | −0.54 |
| MBand | −0.75 | 0.51 | −0.93 | 0.00 | −1.70 | 0.87 |
| Wiener | −1.72 | 0.66 | −0.36 | 0.96 | −0.18 | 0.12 |

In some embodiments of the present invention, because the processing is done entirely in the time domain, the effective delay of the audio due to the system depends only on the phase or group delay of the filters. At higher frequencies (above about 2000 Hz), the human auditory system is sensitive to delay in the signals received in each ear for determining the source of a sound. At lower frequencies, the human auditory system is more concerned with the relative phase of signals. In some embodiments of the present invention, the filter bank can be modeled based on the cochlea filters; therefore, the filters in these embodiments can have narrow bandwidths at lower frequencies and wider bandwidths at higher frequencies. In some embodiments where Butterworth filters with 2^{nd} order roll-off are used, the delay of the filters can be about two periods at any given frequency. In some embodiments of the present invention, the group delay can be less than one millisecond for frequencies above 2000 Hz, and for lower frequencies, the phase delay can be about 4 pi. However, other embodiments of the present invention may have even shorter delays by using low-delay filters, which are known to those of ordinary skill in the art. This shortened delay is a significant improvement over the prior noise suppressions systems mentioned herein, which may have delays of over 20 milliseconds.

In some embodiments of the present invention, the gain G is based on two-dimensional time-frequency window. In these embodiments, the expansion constant K can represent the segmental SNR of the signal. A method of estimating the expansion constant is described in Use of Sigmoidal-Shaped Function for Noise Attenuation in Chochlear Implants, Hu et al., JASA Express Letters, September 2007. The expansion constant K in the i^{th} channel can be expressed as,

$$K ( i , t ) = {e}^{\frac{- 2}{SNR ( i , t )}} \qquad Equation 17$$

where SNR(i,t) is the estimated SNR in the i^{th} channel for time “t”. While the above reference uses Equation 17 as a direct measure of gain, embodiments of the present invention use Equation 17 to set the value of the expansion constant K, which in turn determines the gain while also taking into account relative signal strength.

Methods of calculating the SNR of a signal should not be limited to those disclosed herein, but should also include those methods known to those of ordinary skill in the art, such as the method described in Noise Estimation by Minima Controlled Recursive averaging for robust Speech Enhancement, IEEE Signal Processing Letter, January 2002.

Other embodiments of the present invention use perceptual post-processing on BSS outputs to suppress noise in signals from multiple microphone systems. Noise suppression can be obtained by mapping the minimum of the envelopes of an input signal in each critical band, which corresponds to the noise floor of that band, to a fraction of its value. Because embodiments of this invention map the envelopes based on the human auditory perceptual model, the resulting signal can be more natural sounding.

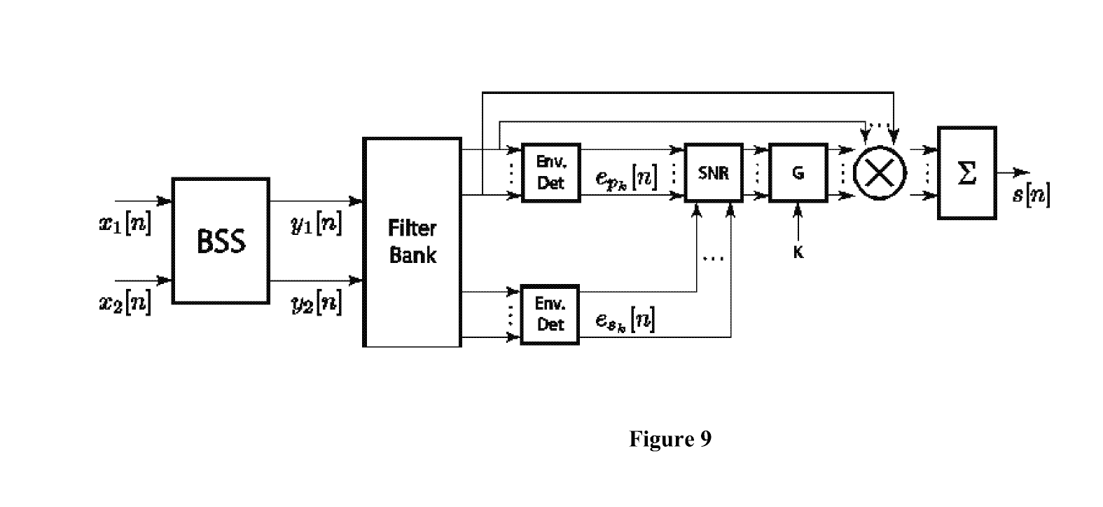

Referring now to FIG. 9, a block diagram of an exemplary embodiment of the present invention is shown that perceptually post-processes BSS outputs to suppress noise in signals. Given that the signal of interest in the system is contained in the channel γ₁[n], which can be obtained from BSS, channel γ₁[n] can be referred to as the primary channel. Channel γ₂[n] can be referred to as the secondary channel. The output obtained from the BSS processing can be applied to a filter bank to decompose the signal into sub-bands. In an exemplary embodiment, a constant-Q filter bank can be used. The envelope can then be extracted from each sub-band and an estimate of the SNR can be obtained in each sub-band. The gain G that is applied to the sub-bands can be calculated using the estimate of the SNR. The weighted sub-bands can then be added to obtain the noise suppressed speech.

In an exemplary embodiment, the gain G can be calculated using the following equation,

G=β(eₚₖ[n])^{α-1} Equation 18

where eₚₖ[n] is the envelope of the k^{th} frequency band of the primary channel and β and α are scaling and expansion factors than can be calculated on the basis of the SNR of the signal (M) and the amount of expansion (K) that is desired. These factors can be calculated in the following equations,

$$\begin{matrix}β = {( max ( {e}_{{p}_{k}} [ n ] ) )}^{( 1 - α )} & Equation 19 \\ α = 1 - \frac{log K}{log M} & Equation 20\end{matrix}$$

The envelope of the primary speech can provide an estimate of the speech level, while the secondary channel can be scaled by the residual mixing gain γ[n] to provide an estimate of the noise level present in the primary signal. The average SNR can be estimated by the following equation,

$$M = \frac{max ( {e}_{{p}_{k}} [ n ] )}{max ( γ [ n ] \cdot {e}_{{s}_{k}} [ n ] )} \qquad Equation 21$$

where, max(eₚₖ[n]) and max(eₛₖ[n]) are the maximum of the envelopes of the k^{th} frequency band of the primary and secondary channel respectively.

Because the entire envelope of the primary and secondary signals can be accessed, the value of γ can be determined. When the primary speech is not active, the value of γ can be determined by the following equation,

$$λ [ n ] = \frac{{e}_{{p}_{k}}^{2} [ n ]}{{e}_{{s}_{k}}^{2} [ n ]} \qquad Equation 22$$

When the speech is active, a value of γ can be set to the mean of the γ calculated during the silence period. The combination of the fact that an accurate estimate of the noise spectrum and a time-varying γ can be accessed allows non-stationary noise cases to be successfully processed.

In an exemplary embodiment the value of K that determines how much the envelopes are expanded can be set to 0.03. The gain G can then be calculated and applied to each sub-band. All the sub-bands can then be added up to obtain a noise suppressed signal.

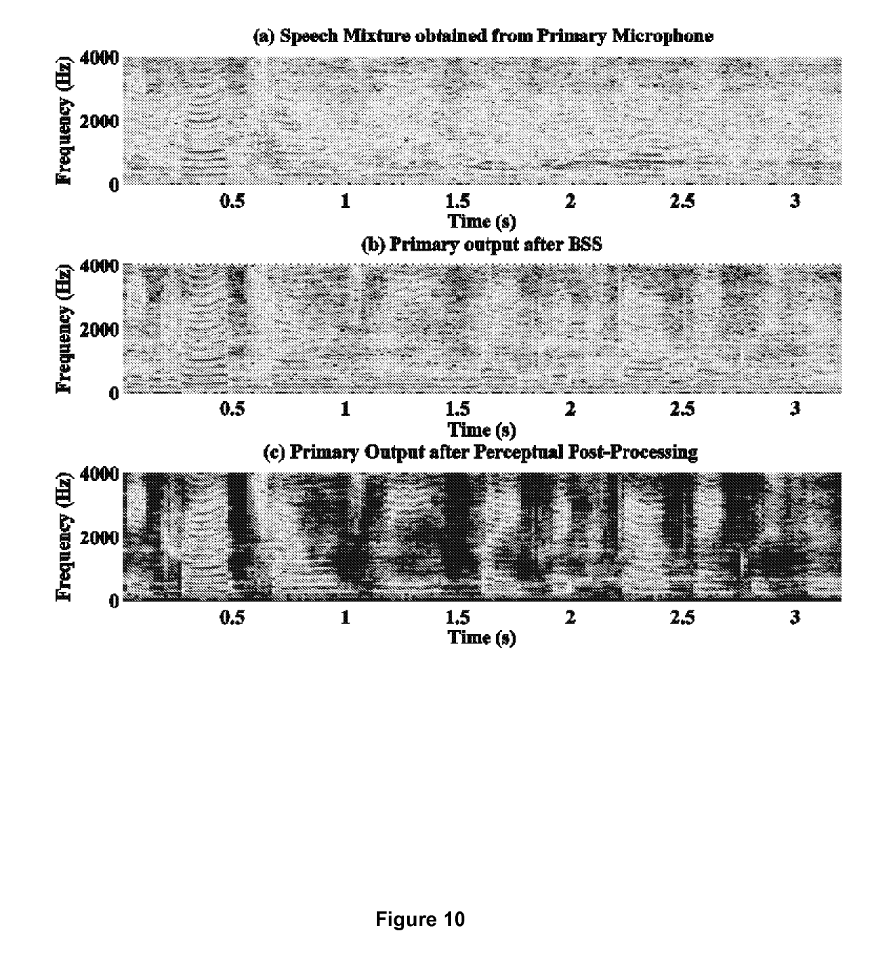

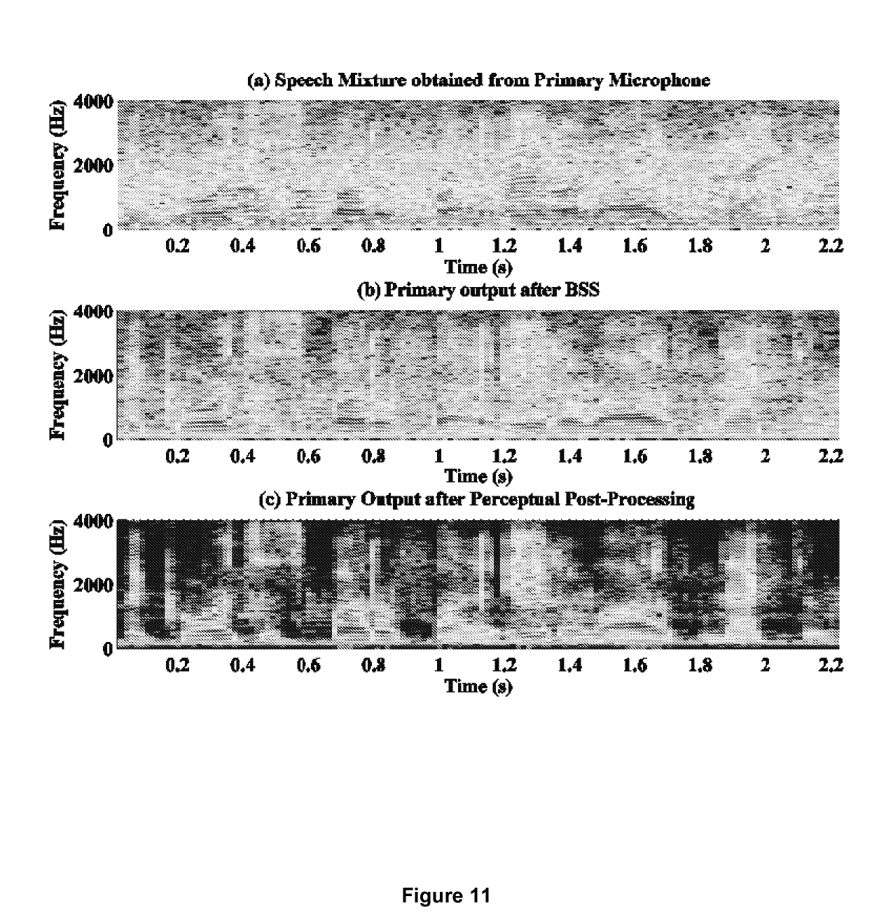

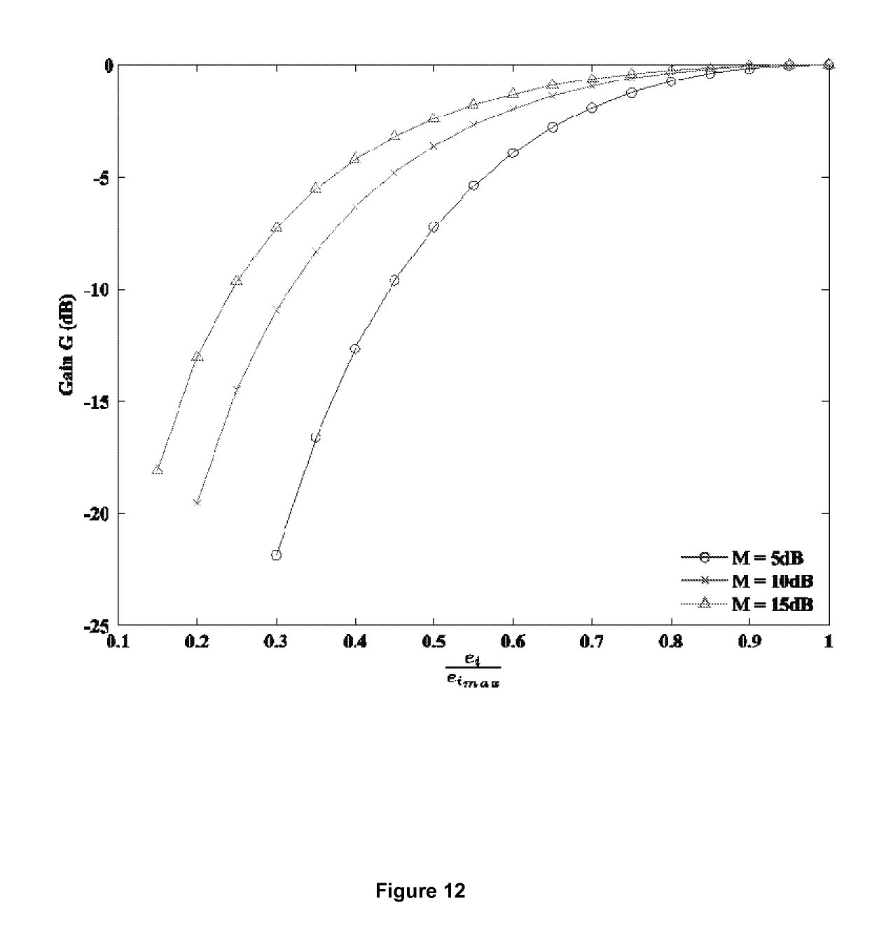

FIGS. 10 and 11 illustrate graphical illustrations of an exemplary perceptual post-processed BSS output signal and the actual mixture. From the spectrograms, the noise level has been reduced without distorting the speech spectrum. A subjective test was conducted to determine the quality of a perceptual post-processed BSS signal from an embodiment of the present invention. Ten native English speakers were recruited and asked to rate the speech samples presented to them on a scale of one to five, one being the worst and five being the best. Forty samples were presented to the subjects. These samples included ten samples that were unprocessed outputs of BSS, ten samples that were perceptually post-processed (P-PP) by an embodiment of the present invention, ten samples that were post-processed by a Wiener filter (WF-PP), five mixtures obtained from the microphones and five clean speech signals. The results of this test are illustrated in Table 4. From Table 4, the perceptual post-processing embodiment of the present invention does not alter the speech quality of the output of BSS. There is also dramatic improvement in the noise level and overall rating of the perceptual post-processed output as compared to the unprocessed output of BSS and the post-processing done with a Wiener filter.

TABLE 4

| | Speech Quality | Noise Level | Overall |
|---|---|---|---|
| WF-PP | 3.6 | 4.1 | 3.4 |
| BSS | 4.1 | 3.2 | 3.6 |
| Mixture | 2.9 | 2.8 | 1.9 |
| Clean | 4.8 | 4.6 | 4.8 |

Some embodiments of the present invention relate to a noise suppression system comprising a filter bank, a plurality of channels, and a signal summation device. The filter bank can contain a plurality of filters. The filters can be any type of filter known to those of ordinary skill in the art, including but not limited to bandpass filters, lowpass filters, highpass filters, IIR filters, FIR filters, and the like. The filter bank can be configured to receive an input signal. The input signal can contain an intended signal and/or noise. The intended signal can be an auditory signal. The auditory signal can contain speech. The input signal can also be any other type of signal known in the art, including but not limited to instrument signals, control signals, and the like. The filter bank can be in communication with a plurality of channels.

In some embodiments, the plurality of channels can correspond to predetermined frequency ranges. The frequency ranges can be predetermined according to the passbands in filters of the filter bank. Each channel can be configured to receive a sub-band signal. The sub-band signal can be generated by the filter bank and can have a predetermined frequency range. Each channel in the plurality of channels can comprise a gain calculation subsystem. Each channel can also comprise a gain multiplier device. The gain calculation subsystem can calculate a gain to be applied to the channel's sub-band signal. The gain calculation subsystem can perform the calculation using the methods and formulas described herein. The gain can be a function of an active estimate of the envelope of the sub-band signals. The multiplier device can be configured to apply the calculated gain to the channel's sub-band signal. In some embodiments, the plurality of channels can be in communication a signal summation device. The signal summation device can combine the gain compensated sub-band signals to form an output signal. In some embodiments of the present invention, a BSS system can be in communication with the filter bank. The BSS system can output signals that are filtered in the filter bank.

In some embodiments of the present invention, the delay of the system is less than one millisecond. In some embodiments, the delay from the system is dependent only on the group delay of the filters.

In other embodiments, the gain in each channel can be a function of an active estimation of the noise floor of the envelope of a sub-band signal. The estimation can be performed with the methods and formulas described herein. In some embodiments the gain in each channel decreases as the SNR of each sub-band decreases. The gain can be close to unity when the SNR of the sub-band signal is very high. The gain can be close to zero when the SNR of the sub-band is very low. The gain can be a function of the envelope of a sub-band signal. The envelope can be calculated using the methods and formulas described herein. The gain can also be a function of the envelope of a signal raised to a power. The function can implement logarithmic and/or exponential functions; however, embodiments of the present invention do not require that logarithmic and/or exponential functions be implemented to calculate gain. The gain can be a function of the noise floor of the sub-band signal. The noise floor of the sub-band signal can be calculated using methods and formulas described herein. The gain can also be a function of the SNR of a sub-band signal. The SNR of a sub-band signal can be calculated using the methods and formulas described herein. The gain can also be a function of the expansion constant of a sub-band signal. The expansion constant of a sub-band signal can be calculated using the methods and formulas described herein.

In some embodiments, the gain calculation subsystem comprises an envelope detection device. The envelope detection device can be configured to calculate the instantaneous envelope or the near instantaneous envelope of the sub-band signal. The envelope detection device can make these calculations using the methods and formulas described herein. The gain calculation subsystem can also comprise a SNR estimation device. The SNR estimation device can estimate the noise floor and the SNR of a sub-band signal. In some embodiments, the SNR estimation device uses memory to estimate the noise floor based on prior calculations of the noise floor. The gain calculation subsystem can also comprise an expansion constant calculation device that calculates the expansion constant to be applied to the sub-band signal. The expansion constant can be calculated using the methods and formulas described herein. The gain calculation subsystem can also comprise a gain calculation device. The gain calculation device can calculate the gain to be applied to the sub-band signal by the multiplier device. The gain calculation device can use information obtained from the envelope detection device, the SNR estimation device, and the expansion constant calculation device to calculate the gain using the methods and formulas described herein.

In some embodiments a filter system is in communication with the multiplier unit and the signal summation device, such that each sub-band signal passes through the filter system after leaving the multiplier unit and before entering the signal summation device. The filter system can contain a plurality of filters. The filter system can be configured to remove any distortion present in the sub-band signals due to the system.

Other embodiments of the present invention relate to a method of suppressing noise in a signal. The method can comprise providing an input signal, filtering the input signal to a plurality of sub-band signals, calculating a separate gain for each sub-band signal, applying the calculated gains to each sub-band signal, and combining the plurality of sub-band signals to form a processed output signal. The sub-band signals can have predetermined frequency ranges corresponding to the passbands of filters in the filter bank. The gain can be a function of an active estimate of envelopes of each of the plurality of sub-band signals. In some embodiments of the present invention, the input signal is the output signal of a BSS system.

In some embodiments of the present invention, the method of suppressing noise in a signal has a delay from input to output of less than one millisecond. In some embodiments, calculating a gain of each sub-band signal requires no computational delay. The system delay in some embodiments arises solely from the group delay of the filters.

It is to be understood that the embodiments and claims of this invention are not limited to use in processing speech signals, but as those of ordinary skill in the art would understand, the systems and methods of the present invention may be used to suppress noise in all types of signals.

It is further to be understood that the embodiments and claims are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the U.S. Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way. It is intended that the application is defined by the claims appended hereto.

What is claimed is:

1. A noise suppression system, comprising:
a filter bank comprising a plurality of filters and configured to receive an input signal;
a plurality of channels in communication with the filter bank, each channel configured to receive a sub-band signal with a predetermined frequency range, each channel comprising a gain multiplier device and a gain calculation subsystem configured to map a gain to be applied to the sub-band signal by the gain multiplier device; and
a signal summation device in communication with the plurality of channels,
wherein the gain is a function of an active estimate of the envelope of the sub-band signal.

2. The noise suppression system according to claim 1, wherein the system is configured so that a delay of the system is less than one millisecond for signals of having a frequency greater than 2 kHz.

3. The noise suppression system according to claim 1, wherein the gain is a function of an active estimation of the noise floor of the envelope of the sub-band signal.

4. The noise suppression system according to claim 1, wherein each of the filters in the filter bank has a bandwidth corresponding to a portion of the human auditory system.

5. The noise suppression system according to claim 1, wherein the gain calculation subsystem comprises an envelope detection device, a SNR estimation device, an expansion constant calculation device, and a gain calculation device.

6. The noise suppression system according to claim 5, wherein the envelope detection device extracts envelopes that have a bandwidth corresponding to a bandwidth of the sub-band signals.

7. The noise suppression system according to claim 1, wherein the gain to be applied to the sub-band signal decreases as a signal-to-noise ratio of the sub-band signal decreases.

8. The noise suppression system according to claim 1, further comprising a blind source separation system in communication with the filter bank.

9. The noise suppression system according to claim 1, further comprising a filtering system in communication with the plurality of channels.

10. A method of suppressing noise in a signal, the method comprising:
receiving an input signal at a plurality of channels;
filtering the input signal in a first channel to provide a first sub-band signal with a frequency corresponding to a first passband of a first filter;
calculating a first gain to be applied to the first sub-band signal, wherein the first gain is a function of an active estimate of an envelope of the first sub-band signal;
applying the first gain to the first sub-band signal;
filtering the input signal in a second channel to provide a second sub-band signal with a frequency corresponding to a second passband of a second filter;
calculating a second gain to be applied to the second sub-band signal, wherein the second gain is a function of an active estimate of an envelope of the second sub-band signal
applying the second gain to the second sub-band signal; and
combining at least the first sub-band signal and second sub-band signal to form an output signal.

11. The method of suppressing noise in a signal according to claim 10, wherein the calculating a first gain comprises:
measuring the envelope of each sub-band signal;
estimating the signal-to-noise ratio of each sub-band signal; and
calculating an expansion constant for each sub-band signal.

12. The method of suppressing noise in a signal according to claim 10, wherein the first gain is a function of an active estimate of a noise floor of the envelope of first sub-band signal.

13. The method of suppressing noise in a signal according to claim 10, wherein the receiving an input signal, filtering the input signal to a first sub-band signal, calculating a first gain, and applying the first gain occurs within one millisecond if the input signal has a frequency above 2 kHz.

14. The method of suppressing noise in a signal according to claim 10, wherein the calculating a first gain requires no computational delay.

15. The method of suppressing noise in a signal according to claim 10, wherein the input signal is an auditory signal comprising speech.

16. The method of suppressing noise in a signal according to claim 10, wherein the input signal is an output of a blind source separation system.

17. A noise suppression system, comprising:
a filter bank comprising a plurality of filters having bandwidths and configured to receive an auditory speech input signal;
a plurality of channels in communication with the filter bank, each channel configured to receive a sub-band signal with a predetermined frequency range, each channel comprising a gain multiplier device and a gain calculation subsystem configured to map a gain to be applied to the sub-band signal by the gain multiplier device; and
a signal summation device in communication with the plurality of channels,
wherein the gain is a function of an active estimate of the noise floor the sub-band signal, the gain decreasing as a signal-to-noise ratio of the sub-band signal decreases.

18. The noise suppression system according to claim 17, further comprising a filter system in communication with the plurality of channels and configured to remove distortion in the sub-band signal.

19. The noise suppression system according to claim 17, wherein the gain calculation subsystem comprises an envelope detection device, a SNR estimation device, an expansion constant calculation device, and a gain calculation device.

20. The noise suppression system according to claim 17, further comprising a blind source separation system in communication with the filter bank.
